(19) United States
(12) Patent Application Publication
(10) Pub. No.: US 2022/0163744 A1
(43) Pub. Date: May 26, 2022

(54) CHASSIS PANEL WITH SELECTABLE CABLE MANAGEMENT INSERT AND CABLING METHOD THEREFORE

(71) Applicant: COMMSCOPE TECHNOLOGIES LLC, Hickory, NC (US)

(72) Inventor: Rodney C. SCHOENFELDER, Shakopee, MN (US)

(73) Assignee: COMMSCOPE TECHNOLOGIES LLC, Hickory, NC (US)

(21) Appl. No.: 17/614,295

(22) PCT Filed: May 20, 2020
(86) PCT No.: PCT/US2020/033747

§ 371 Date: Nov. 24, 2021

Related U.S. Application Data
(60) Provisional application No. 62/852,571, filed on May 24, 2019.

(51) Int. Cl. G02B 6/44; G02B 6/36

(52) U.S. Cl. CPC G02B 6/4453; G02B 6/3616

(57) ABSTRACT

A chassis panel defines one or more rearward-facing, open-ended slots at a rear of the chassis panel. One or more management inserts can be mounted within the open-ended slot along a forward-rearward axis. Cables can be pre-cabled through the inserts prior to being installed at one or more port modules. Accordingly, the port modules can be cabled prior to being installed at the chassis panel without first having to thread the cables through the chassis panel. Alternatively, the cables can be slid directly into the open-ended slots during installation of the port modules.

### CROSS-REFERENCE TO RELATED APPLICATION

This application is being filed on May 20, 2020 as a PCT International Patent Application and claims the benefit of U.S. Patent Application Ser. No. 62/852,571, filed on May 24, 2019, the disclosure of which is incorporated herein by reference in its entirety.

### BACKGROUND

Chassis panel systems can hold a plurality of ports at which connections can be made. For example, one or more optical adapters can be mounted within a chassis. Of course, electrical jacks or other port modules also can be mounted within the chassis. In some cases, the port modules can be mounted to movable (e.g., slidable) trays or blades within the chassis. Cables connected to rear-facing ports of the port modules extend towards the rear of the chassis. A cable management module is typically disposed at the rear of the chassis to manage the cables during movement of the trays or blades.

Sidewalls of the cable management module define apertures through which the cables enter the chassis. In some implementations, the apertures are defined by the module sidewalls. In other implementations, the apertures are defined by plates mounted to the module sidewalls. For example, FIG. 30 illustrates an example in which plates P defining multiple apertures A are disposed at the sidewalls of the cable management module C. In such implementations, the cables 180 can be anchored at brackets B spaced from the module sidewalls or otherwise anchored to the chassis or to the rack. In other implementations, the apertures A are defined by cable glands G, cable anchors, or other such structures mounted at the sidewalls of the cable management module C. For example, FIG. 31 illustrates an example management module M suitable for mounting to the rear of a chassis. The management module M receives plates P of cable glands G at which cables 180 can be anchored.

To cable the chassis shown in either FIG. 30 or 31, the cables 180 are threaded through the apertures A prior to being connected to the rear-facing ports of the port modules. In some cases, the cables 180 are threaded through the apertures A prior to mounting the rear-facing ports within the chassis. Once installed, the cables 180 inhibit removal of the rear-facing ports from the chassis without first unconnecting the cables 180 from the rear-facing ports. Otherwise, the cables 180 either physically block rearward movement of the port modules past the apertures A or tether a forward-moving tray to the chassis. The cables 180 must be removed from the rear-facing ports to unthread the cables 180 from the apertures A.

Improvements are desired.

### SUMMARY

Aspects of the disclosure are directed to a chassis panel, a cable management arrangement therefore, and methods for cabling the same.

In certain implementations, cables can be installed at a port module prior to the port module being installed within a chassis. In certain examples, the cables need not be routed to or installed at the chassis prior to installing the cables at the port module.

In certain implementations, the cables are installed at the chassis panel by sliding the cables along a forward-rearward axis relative to the chassis panel.

In certain implementations, the cables are pre-installed at a cable management insert prior to being installed at the chassis panel. In certain examples, the cables are pre-installed at the cable management insert prior to being installed at the port module.

In certain implementations, any of a variety of cable management inserts can be selected to be mounted at the chassis panel. In certain examples, each of the cable management inserts is configured to releasably lock to the chassis panel. For example, each management insert may latch to the chassis panel. In some examples, the management insert may be released from the chassis panel by pulling on the management insert with sufficient force. In other examples, the management insert may be released from the chassis panel by pressing against a handle or other unlatching member.

In certain examples, the selected cable management insert defines an open-ended slot facing rearward. In certain examples, the selected cable management insert defines a plurality of apertures facing sideways relative to the chassis panel. In certain examples, the selected cable management insert carries a plurality of cable anchors. In certain examples, the selected cable management insert carries a plurality of cable glands.

In certain implementations, the chassis panel includes a cable management arrangement is disposed at an open rear of a chassis body. The selected management insert is coupled to the cable management arrangement.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a front perspective view of an example chassis panel including a chassis body, a cable management arrangement, and a removable rear cover configured in accordance with the principles of the present disclosure;

FIG. 2 is a rear perspective view of the chassis panel of FIG. 1;

FIG. 3 is a perspective view of an example blade carrying two example port modules suitable for use with any of the chassis panels disclosed herein;

FIG. 4 is a rear perspective view of the chassis panel of FIG. 2 with the rear cover exploded away from the cable management arrangement;

FIG. 5 is an enlarged, exploded view of the cable management arrangement of FIG. 4 removed from the chassis body;

FIG. 6 is a rear perspective view of the chassis panel of FIG. 4 with one of the blades partially removed from the chassis body so that the blade is disposed at least partially within the cable management arrangement;

FIG. 7 is a top perspective view of an example open-ended slot defined by the cable management arrangement and guide arrangement mounted thereat;

FIG. 8 is a bottom perspective view of the example open-ended slot and guide arrangement of FIG. 7;

FIG. 9 is a top perspective view of an enlarged portion of the guide arrangement of FIGS. 7 and 8 in which a resilient tab is visible;

FIGS. 10 and 11 illustrate a first example implementation of a cable management insert suitable for being received at the guide arrangement at the open-ended slot of the cable management arrangement;

FIGS. 12 and 13 illustrate a second example implementation of a cable management insert suitable for being received at the guide arrangement at the open-ended slot of the cable management arrangement;

FIGS. 14 and 15 illustrate a third example implementation of a cable management insert suitable for being received at the guide arrangement at the open-ended slot of the cable management arrangement;

FIGS. 16 and 17 illustrate a fourth example implementation of a cable management insert suitable for being received at the guide arrangement at the open-ended slot of the cable management arrangement;

FIGS. 18 and 19 illustrate a fifth example implementation of a cable management insert suitable for being received at the guide arrangement at the open-ended slot of the cable management arrangement;

FIGS. 20 and 21 illustrate a sixth example implementation of a cable management insert suitable for being received at the guide arrangement at the open-ended slot of the cable management arrangement;

FIGS. 22 and 23 illustrate another example implementation of an insert suitable for being received at the guide arrangement at the open-ended slot of the cable management arrangement;

FIGS. 24 and 25 illustrate an example cable management insert mounted at a guide arrangement disposed at an open-ended slot defined by a cable management arrangement;

FIG. 26 is a front perspective view of another example chassis panel including a chassis body, a cable management arrangement, and a removable rear cover configured in accordance with the principles of the present disclosure;

FIG. 27 is a rear perspective view of the chassis panel of FIG. 26 with the rear cover exploded away to reveal an interior of the cable management arrangement and to expose open ends of the slots;

FIG. 28 is a perspective view of another example chassis panel including a chassis body, a cable management arrangement, and a removable cover configured in accordance with the principles of the present disclosure;

FIG. 29 is a rear perspective view of the chassis panel of FIG. 28 with the rear cover exploded away to reveal an interior of the cable management arrangement and to expose open ends of the slots;

FIG. 30 is a rear perspective view of an example chassis panel defining closed apertures through which the rear cables enter the chassis panel; and

FIG. 31 shows gland plates mounted at the closed apertures.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

The present disclosure is directed to a chassis panel 100, 200 including a chassis body 110, 210, a cable management arrangement 120, 220, and a rear cover 130, 230. The chassis panel 100, 200 extends along a depth between a front 101, 201 and a rear 102, 202, along a width between opposite first and second sides 103, 104, 203, 204, and along a height between a top 105, 205 and a bottom 106, 206.

The chassis body 110, 210 defines an open front 112, 212 at the front 101, 201 of the chassis panel 100, 200. The chassis body 110, 210 also defines an open rear 114, 214. Opposite sidewalls 116, 216 extend between the open front 112, 212 and the open rear 114, 214. Opposite end walls 118, 218 extend between the open front 112, 212 and the open rear 114, 214 and between the opposite sidewalls 116, 216. The chassis body 110, 210 is configured to mount to a rack frame. For example, brackets may be attached to the chassis body 110, 210.

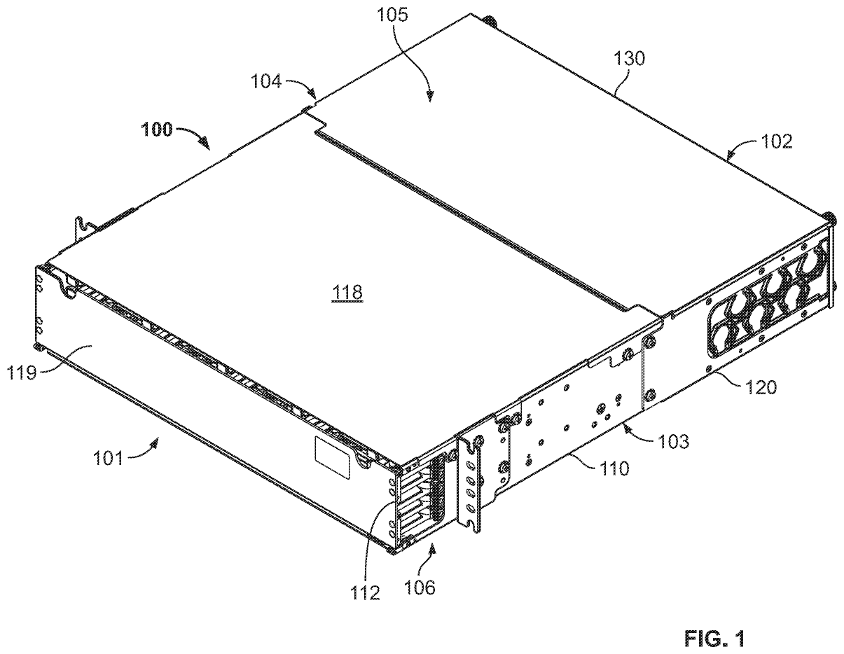

A cover 119, 219 (FIG. 1) may be mounted at the open front 112, 212 of the chassis body 110, 210 to selectively cover the open front 112, 212. The cover 119, 219 may be movable between a closed position and an open position. The cover 119, 219 inhibits access to an interior of the chassis body 110, 210 through the open front 112, 212 when the cover 119, 219 is disposed in the closed position. The cover 119, 219 allows access to an interior of the chassis body 110, 210 through the open front 112, 212 when the cover 119, 219 is disposed in the open position.

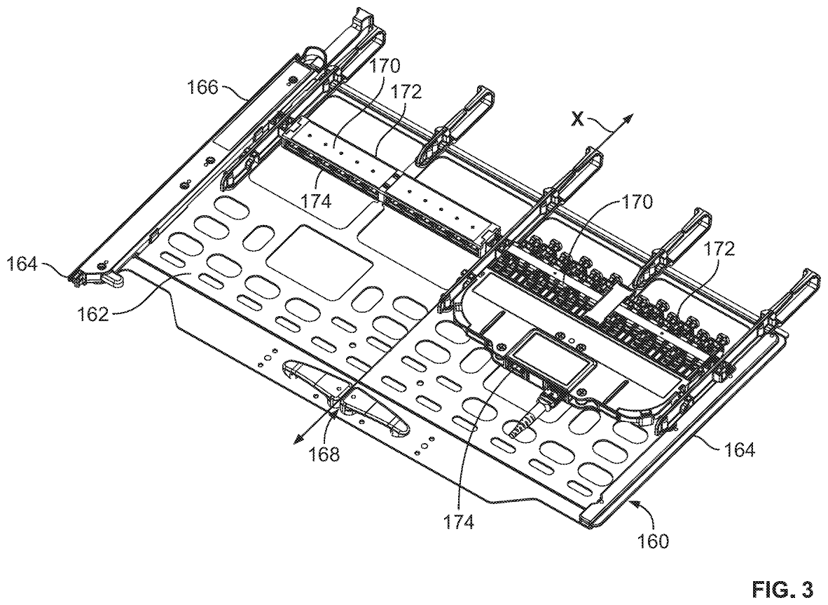

One or more port modules 170 are disposed within the chassis body 110, 210 (e.g., see FIG. 3). Each port module 170 has at least one forward-facing port 172 and at least one rearward-racing port 174. In certain implementations, the port modules 170 slide within the chassis body 110 along a forward-rearward axis X. In certain implementations, the port modules 170 are carried by one or more blades 160 that slide within the chassis body 110, 210. In certain examples, the port modules 170 include optical adapters. In certain examples, the port modules 170 include one or more cassettes that each carry one or more optical adapters. In certain examples, the port modules 170 include electrical jacks, hybrid adapters, or other such plug receptacles.

In certain implementations, the chassis body 110, 210 is configured to receive one or more blades 160 each carrying one or more port modules 170. In the example shown in FIG. 3, an example blade 160 includes a body 162 extending between rails 164. Each blade 160 includes a releasable locking arrangement 166 by which the blade 160 is releasably held in one or more discrete positions along the forward-rearward axis X. Each blade 160 also may include cable management 168 at a rear of the blade body 162. In other implementations, the port modules 170 may be otherwise movably mounted within the chassis body 110, 210.

Example chassis bodies 110, 210, covers 119, 219, blades 160, and port modules 170 suitable for use with the chassis panels 100, 200 described herein are disclosed in U.S. Pat. Nos. 8,934,252; 9,709,765; and U.S. Publication No. 2018/0224621, the disclosures of which are hereby incorporated herein by reference in their entirety.

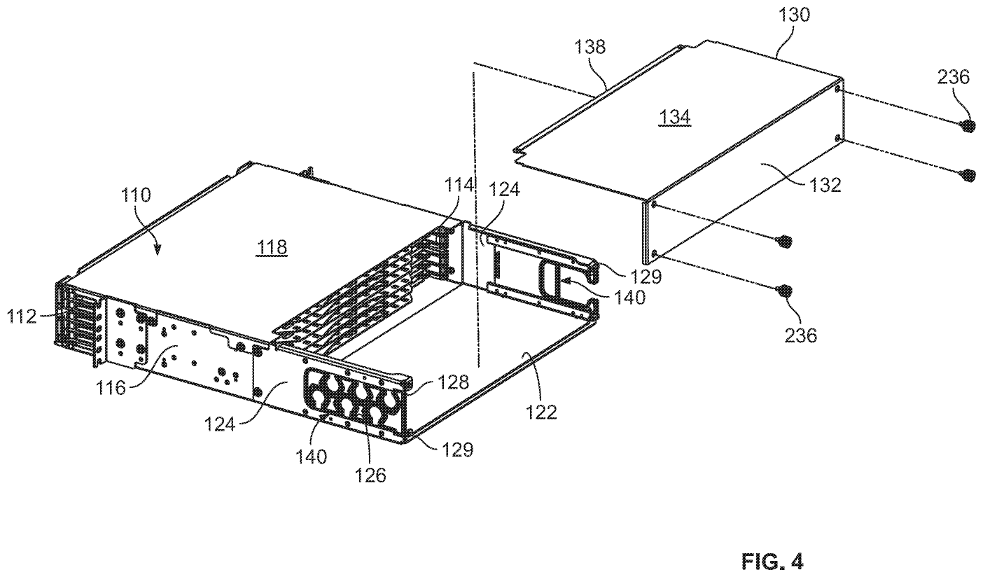

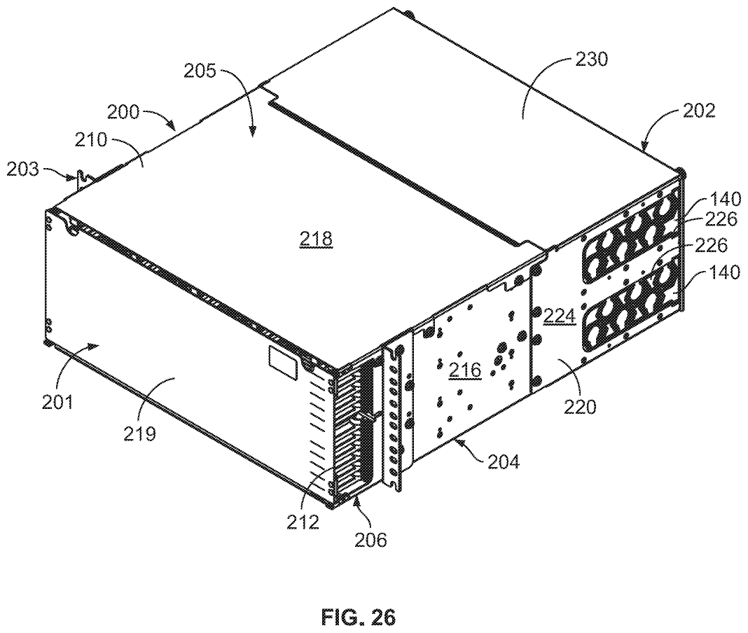

Referring now to FIGS. 4, 5, 26, and 27, the cable management arrangement 120, 220 is disposed at the open rear 114, 214 of the chassis body 110, 210. For example, the cable management arrangement 120, 220 may be coupled directly to the chassis body 110, 210. The cable management arrangement 120, 220 includes two sidewalls 124, 224 extending upwardly from opposite sides of a bottom 122, 222. In certain examples, the sidewalls 124, 224 of the management arrangement 120, 220 are planar or otherwise continuous with the sidewalls 116, 216 of the chassis body 110, 210.

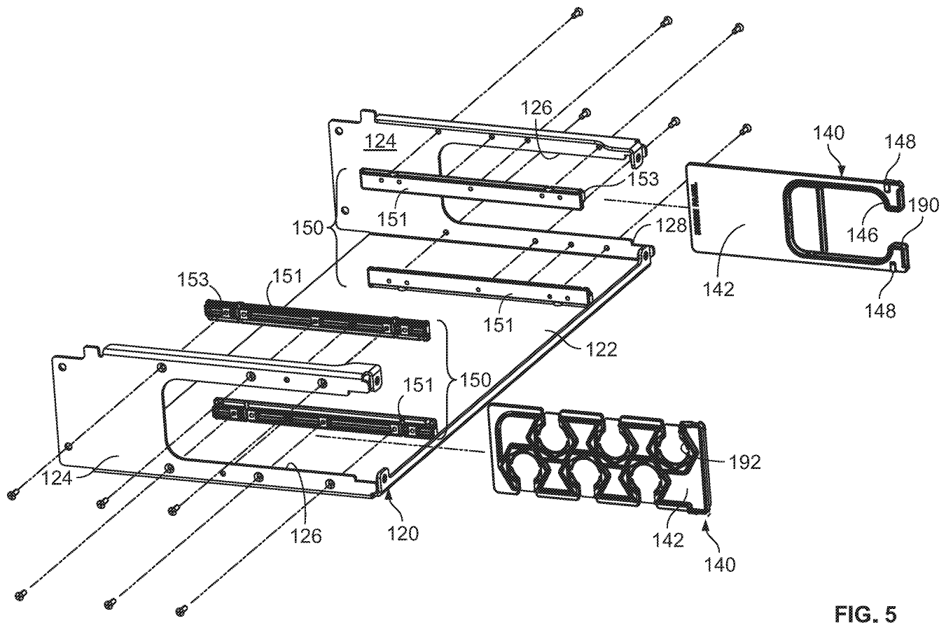

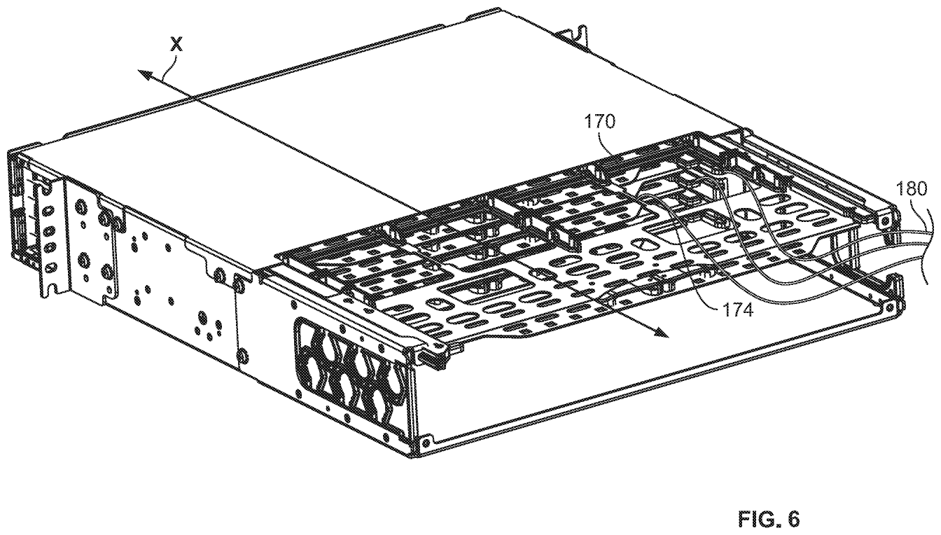

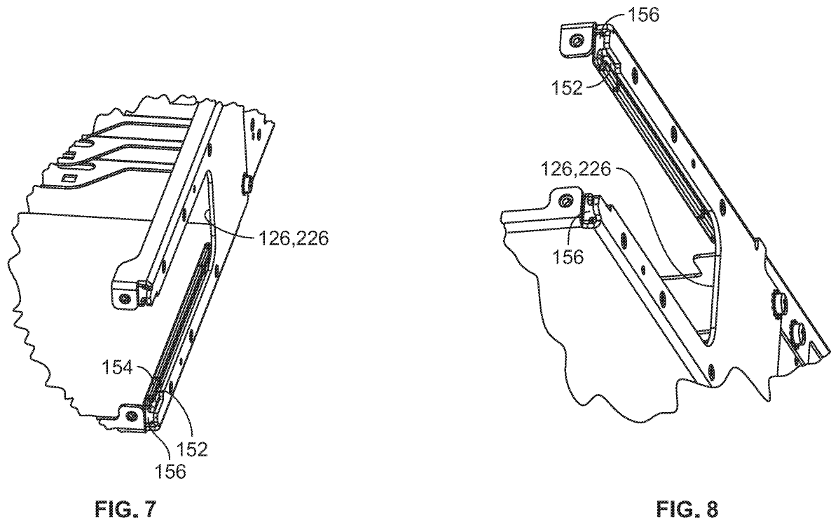

At least one of the sidewalls 124, 224 of the cable management arrangement 120, 220 defines a slot 126, 226 having an open end 128, 228 facing rearward of the chassis panel 100, 200 (see FIG. 5).

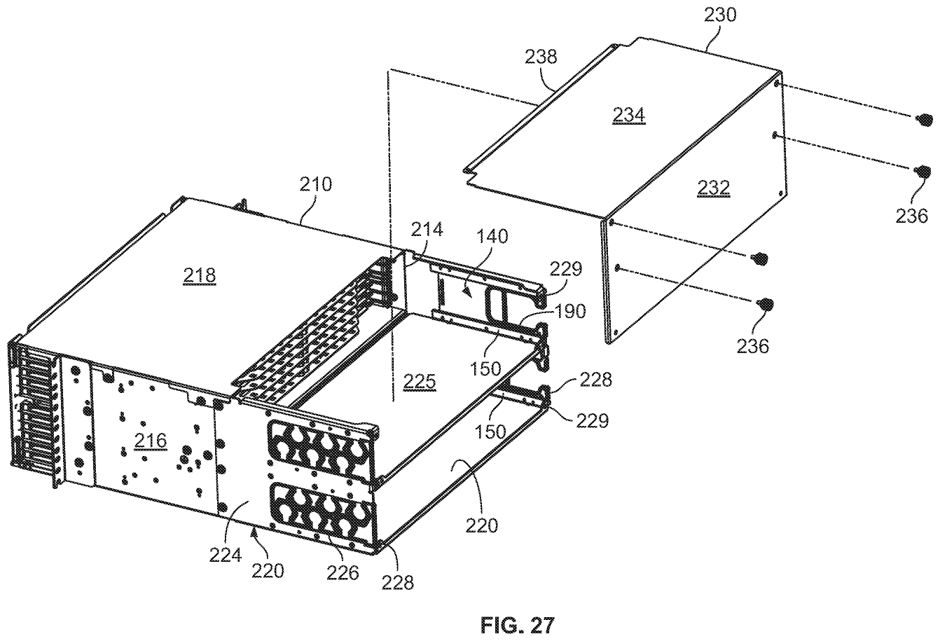

In certain examples, the cable management arrangement 220 includes multiple levels (e.g., see FIG. 27). For example, a dividing plate 225 is disposed within the cable management arrangement 220 to separate a lower level from an upper level. In other examples, multiple dividing plates 225 can be used to create additional levels. Each level of the cable management arrangement 220 has a respective one or more slots 226 having rearward-facing openings 228. For example, each level may have a slot 226 at each side 203, 204 of the cable management arrangement 220. The dividing plate 225 separates the cables 180 routed to the port modules 170 at the top of the chassis panel 200 from the cables 180 routed to the port modules 170 at the bottom of the chassis panel 200. Separating the cables 180 inhibits the weight of the upper cables 180 from crushing or otherwise interfering with the lower cables 180 (e.g., during movement of the port modules 170 along the forward-rearward axis X).

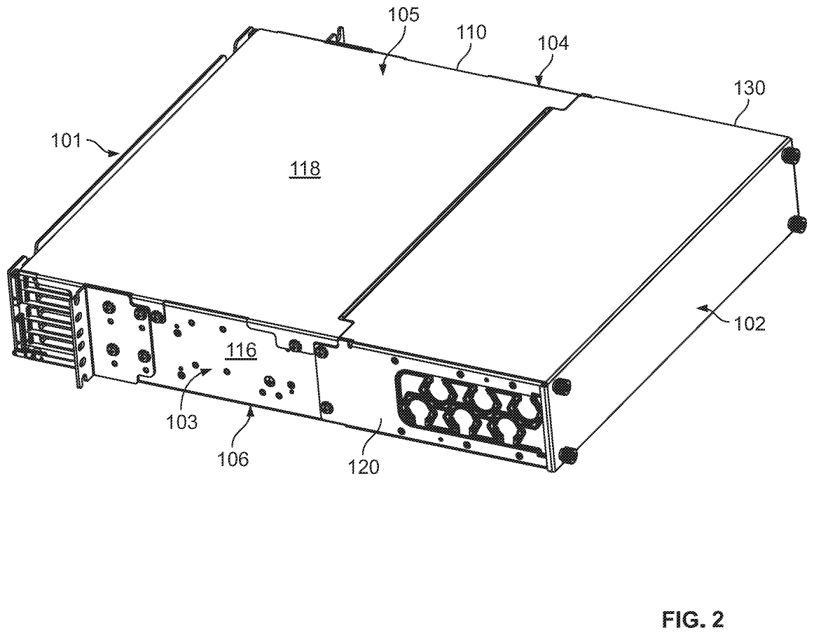

The cover 130, 230 removably mounts to the chassis panel 100, 200 to cover the open rear 114, 214 of the chassis body 110, 220. The cover 130, 230 includes a rear wall 132, 232 that extends across a rear of the chassis panel 100, 200 when mounted to the chassis panel 100, 200 (e.g. see FIG. 2). In certain implementations, the cover 130, 230 removably mounts to the cable management arrangement 120, 220. In certain implementations, the cover 130, 230 includes a top 134, 234 coupled to the rear wall 132, 232. The top 134, 234 extends over an interior of the cable management arrangement 120, 220 when the cover 130, 230 is mounted to the cable management arrangement 120, 220. In certain examples, the top 134, 234 of the cover 130, 230 is parallel to the bottom 122, 222 of the management arrangement 120, 220 when the cover 130, 230 is mounted to the cable management arrangement 120, 220.

In certain implementations, the cover 130, 230 is secured to the chassis panel 100, 200 using one or more fasteners 136, 236. For example, screws can be inserted through the rear wall 132, 232 and into receiving tabs 129, 229 on the cable management arrangement 120, 220. In certain examples, the fasteners 136, 236 can be captive fasteners carried by the cover 130, 230. In other examples, the cover 130, 230 can be latched, friction-fit, or otherwise releasably secured to the chassis panel 100, 200. In certain examples, the top 134, 234 of the cover 130, 230 includes a flange 138, 238 that couples to one of the end walls 118, 218 of the chassis body 110, 210 to inhibit access to the interior of the chassis body 110, 210. For example, a portion of the flange 138, 238 may extend beneath the end wall 118, 218.

When the cover 130, 230 is mounted to the chassis panel 100, 200, the rear wall 132, 232 extends over the open end 128, 228 of the slot 126, 226 defined in the sidewall 124, 224 of the cable management arrangement 120, 220. Accordingly, the rear wall 132, 232 blocks access to the slot 126, 226. In certain examples, the rear wall 232 extends over the open ends 228 of all of the slots 226 on each level. Accordingly, the mounting the cover 230 to the cable management arrangement 220 closes all of the slots 126, 226 on all levels simultaneously. When the cover 130, 230 is removed from the chassis panel 100, 200, the slot 126, 226 is accessible through the open end 128, 228. In certain implementations, each of the sidewalls 124, 224 of the cable management arrangement 120, 220 defines a respective slot 126, 226 having a respective open end 128, 228 that faces rearward. In such implementations, the rear wall 132, 232 of the cover 130, 230 may extend over the open ends 128, 228 of both slots 126, 226 when mounted to the chassis panel 100, 200.

In accordance with some aspects of the disclosure, cabled port modules 170 can be installed at the chassis panel 100, 200. First, a connectorized end of a cable 180 can be plugged into a rear-facing port 174 of a port module 170. Second, the cabled port module 170 can be inserted into the chassis body 110, 210 through the open rear 114, 214.

For example, if the chassis panel 100, 200 includes a cover 130, 230, then the cover 130, 230 is removed to provide access to the open rear 114, 214. The port module 170 can then be slid through the cable management arrangement 120, 220 along the forward-rearward axis X and through the open rear 114, 214 of the chassis body 110, 210. As the port module 170 is slid into the chassis panel 100, 200, the cable 180 extending rearwardly from the port module 170 slides into the slot 126, 226 through the open end 128, 228 along the forward-rearward axis X. The cable 180 can be secured at the chassis panel 100, 200 by mounting the cover 130, 230 to the chassis panel 100, 200 to cover the open end 128, 228 of the slot 126, 226. In certain examples, the cable 180 can be separately anchored to the chassis panel 100, 200 (e.g., using a clamp, a cable tie, or other anchoring mechanism).

Advantageously, the cables 180 slide into the cable management arrangement 120, 220 instead of needing to be threaded therethrough. Accordingly, the cables 180 can be slid into the chassis panel 100, 200 after being installed at the port module 170 without first being routed through the chassis panel 100, 200. Therefore, a worker can cable multiple port modules 170 at a location spaced (or remote) from the chassis panel 100, 200 and can subsequently bring the port modules 170 and cables 180 to the chassis panel 100, 200 for installation.

A cabled port module 170 also can be removed from the chassis panel 100, 200 without disconnecting the cable 180 from the port module 170. For example, the cover 130 can be removed from the chassis panel 100, 200 to expose the open ends 128, 228 of the slots 126, 226 and to expose the open rear 114, 214 of the chassis body 110, 210. A user grasps the port module 170 (or blade 160 carrying the port module 170) and pulls the port module 170 rearwardly relative to the housing 110, 210 along the forward-rearward axis X. As the port module 170 moves rearwardly, the cable(s) 180 extending to the rear-facing port 174 of the port module 170 slide(s) out of the slot 126, 226 through the open-end 128, 228 along the forward-rearward axis X.

Advantageously, the cable(s) 180 slide out of the cable management arrangement 120, 220 instead of needing to be threaded therethrough. Accordingly, the cables 180 do not block removal of the port module 170 if the port module 170 (or blade 160) extends a majority of the width of the chassis body 110, 210. Rather, the cables 180 can be moved out of the way (i.e., slid out of the slots 126, 226) as the port module 170 is being removed. Therefore, the cable 180 can remain connected to the port module 170 as the port module 170 is being removed from the chassis panel 100, 200.

In accordance with other aspects of the disclosure, a cable management insert 140 can be mounted at the slot 126, 226 defined in the sidewall 124, 224 of the cable management arrangement 120, 220. In some implementations, the cable 180 is installed at the cable management insert 140, 240 prior to plugging the connectorized end of the cable 180 into the rear-facing port 174 of the port module 170. The port module 170 and the management insert 140 are then installed together at the chassis panel 100, 200. In other implementations, the management insert 140 is installed at the cable management arrangement 120, 220 and the cable 180 is subsequently installed at the cable management insert 140 when the port module 170 is installed at the chassis panel 100, 200.

Advantageously, even when using the cable management inserts 140, the cable 180 need not be pre-threaded through (or otherwise routed through) the chassis panel 100, 200 prior to being plugged into the port module 170. For example, in some implementations, the cable management inserts 140 define rear-facing slots. Even if the management insert 140 defines apertures instead of slots, the cable 180 can be threaded through the management insert 140 when the management insert 140 is disconnected from the chassis panel 100, 200. The management inserts 140 are small and lightweight. Accordingly, needing to pre-thread the cable 180 through the management insert 140 is less troublesome than needing to pre-thread the cable 180 through the chassis panel 100, 200 (i.e., through the cable management arrangement 120, 220 or chassis body 110, 210).

In certain implementations, the cable management insert 140 is configured to slide into the slot 126, 226 along the forward-rearward axis X as will be disclosed in more detail herein. In other implementations, the management insert 140 could be insertable along a different axis.

In certain examples, the cable management arrangement 120, 220 includes a guide arrangement 150 at the slot 126, 226 for receiving the management insert 140. The guide arrangement 150 include guide members 151 each defining a channel 152 extending along the forward-rearward axis X. In certain examples, the guide arrangement includes two guide members 151 at the top and bottom of the slot 126, 226. The two guide members 151 define opposing channels. The management insert 140 includes a body 142 having edges or rails 144 each sized to fit within a corresponding one of the channels 152 to allow the management insert 140 to slide within the guide arrangement 150.

In certain examples, the guide members 151 are configured to support the dividing plate 225 of the cable management arrangement 220. For example, each guide member 151 may define a support surface 153 on which the dividing plate 225 seats. In an example, a foot or bent edge of the dividing plate 225 rests on the support surface 153. In certain examples, the support surface 153 is recessed relative to a top edge of the guide member 151. In certain examples, the support surface 153 is aligned with the channel 152 and faces in an opposite direction from the channel 152.

In certain examples, the management insert 140 includes a stop tab 146 that abuts a rearward-facing shoulder 156 of the guide arrangement 150 when mounted at the slot 126. Engagement between the stop tab 146 and the rearward-facing shoulder 156 inhibits continued forward movement of the insert 140 within the channels 152.

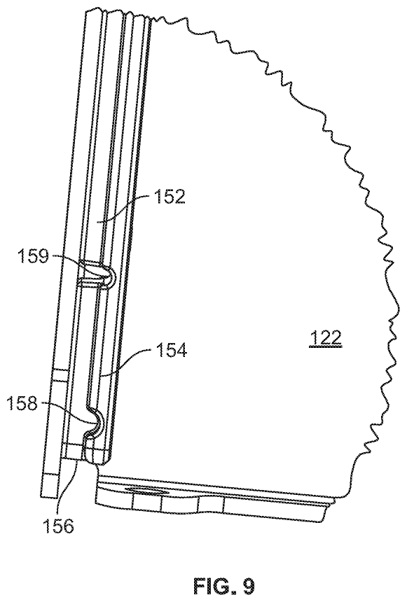

In certain implementations, the cable management insert 140 is releasably lockable to the guide arrangement 150. In certain examples, the cable insert 140 releasably latches to the guide arrangement 150. In certain examples, the guide arrangement 150 also includes a resilient tab 154 and the management insert 140 includes a latch tab 148. The resilient tab 154 defines a notch 158 sized to receive at least part of the latch tab 148. In an example, the resilient tab 154 flexes relative to the cable management arrangement 120, 220 towards and away from the slot 126, 226. For example, the resilient tab 154 may flex at a notch or point of weakness 159 (e.g., see FIG. 9).

When the management insert 140 is inserted into the channels 152 at the slot 126, 226, the latch tab 148 cams along the resilient tab 154, thereby flexing the resilient tab 154 away from the slot 126, 226 and into an interior of the cable management arrangement 120, 220. When the management insert 140 reaches an inserted position, the latch tab 148 reaches the notch 158, thereby allowing the resilient tab 154 to flex back towards the slot 126, 226. Engagement between the latch tab 148 and the notch 158 of the resilient tab 154 holds the management insert 140 in the inserted position at the slot 126, 226.

In certain implementations, to remove the management insert 140 from the cable management arrangement 120, 220, a user pulls on the management insert 140 with sufficient force to cam the latch tab 148 out of the notch 158 and over the resilient tab 154. The user pulls the management insert 140 along the guide channels 152 along the forward-rearward axis X. In other implementations, the user pushes or pulls on the resilient tab 154 to release the latch tab 148 and subsequently pulls the management insert 140 along the guide channels 152. In certain examples, the user pulls the management insert 140 along the forward-rearward axis X.

In accordance with aspects of the disclosure, the management insert 140 can have a variety of forms. In some implementations, the management insert 140 defines one or more open-ended slots 190 facing rearward. Accordingly, one or more cables 180 can be inserted into the cable management insert 140 through the open-ended slot(s) 190 along the forward-rearward axis X. In other implementations, the management insert 140 includes one or more open-ended slots 192 facing upward and/or downward. Accordingly, one or more cable 180 can be inserted into the cable management insert 140 through the open-ended slots(s) 192. In still other implementations, the management insert 140 includes one or more apertures 194. Accordingly, one or more cable 180 can be inserted into the cable management insert 140 by threading the cable(s) 180 through the apertures 194. In still other implementations, the insert 140 can have a solid body 196 that closes the slot 126, 226.

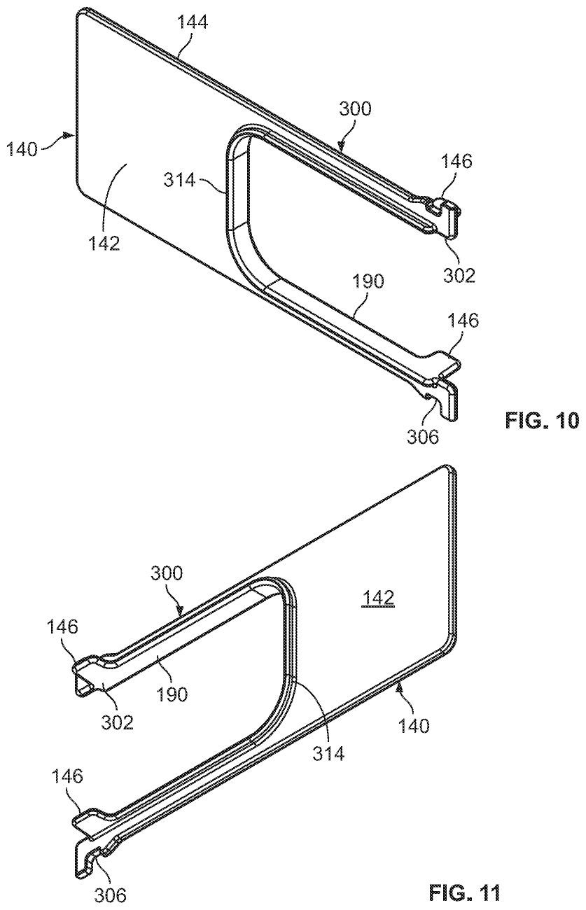

FIGS. 10-23 illustrate various example implementations of suitable cable inserts 140. The management insert implementation to be used is selected from one of a variety of different types of management inserts 140. In various implementations, the type of management insert 140 is selected based on the number of cables 180 to be installed at the chassis panel 100, 200, the shape and size of the cables 180 to be installed at the chassis panel 100, 200, and/or how the cables 180 are to be anchored to the chassis panel 100, 200.

FIGS. 10 and 11 illustrate a first example implementation 300 of a cable insert 140. The cable insert 300 defines an open-ended, rear-facing slot 190. In the example shown, the slot 190 extends about halfway into the body 142 of the insert 300. In other examples, the slot 190 may be deeper or shallower. In the example shown, the slot 190 extends over a majority of a height of the body 142. In other examples, the slot 190 may be thinner. In the example shown, the open end 302 of the slot 190 is substantially the same height as the slot 190. In other examples, a height of the open end 302 may be reduced relative to a height of the slot 190. In the example shown, a raised ridge 304 extend around a periphery of the slot 190. The ridge 304 may define a bend radius limiter or otherwise inhibit excessive bending of cables 180 routed through the slot 190. In the example shown, the cable insert 300 includes latches 306 configured to engage a protruding tab or shoulder on the corresponding guide arrangement 150 or cable management arrangement 120, 220. In other examples, the cable insert 300 may include a latch tab 148. In certain examples, the cable inset 300 includes stopping tabs 146 to engage a rearward facing shoulder 156 of the guide arrangement 150 or cable management arrangement 120, 220.

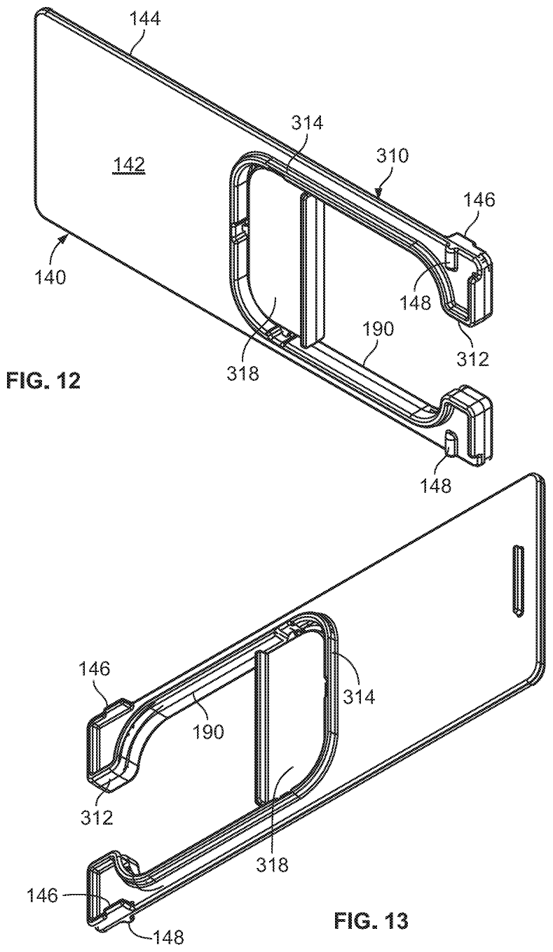

FIGS. 12 and 13 illustrate a second example implementation 310 of a cable insert 140. The cable insert 310 defines an open-ended, rear-facing slot 190. In the example shown, the slot 190 extends less than about halfway into the body 142 of the insert 310. In certain examples, the cable insert 310 includes a removable segment 318 (e.g., a punch-out or tear-away piece) disposed within the slot 190 to reduce the depth of the slot 190. The slot 190 can be enlarged by removing the segment 318. In the example shown, the slot 190 extends over a majority of a height of the body 142. In other examples, the slot 190 may be thinner. In the example shown, the open end 312 of the slot 190 is reduced relative to a height of a remainder of the slot 190. The reduced opening 312 helps to retain the cables 180 within the slot 190 once inserted. In the example shown, a raised ridge 314 extend around a periphery of the slot 190. The ridge 314 may define a bend radius limiter or otherwise inhibit excessive bending of cables 180 routed through the slot 190. In the example shown, the body 142 of the cable insert 310 includes a stop tab 146 and a latch tab 148. In other examples, the insert 310 may have other latching mechanisms.

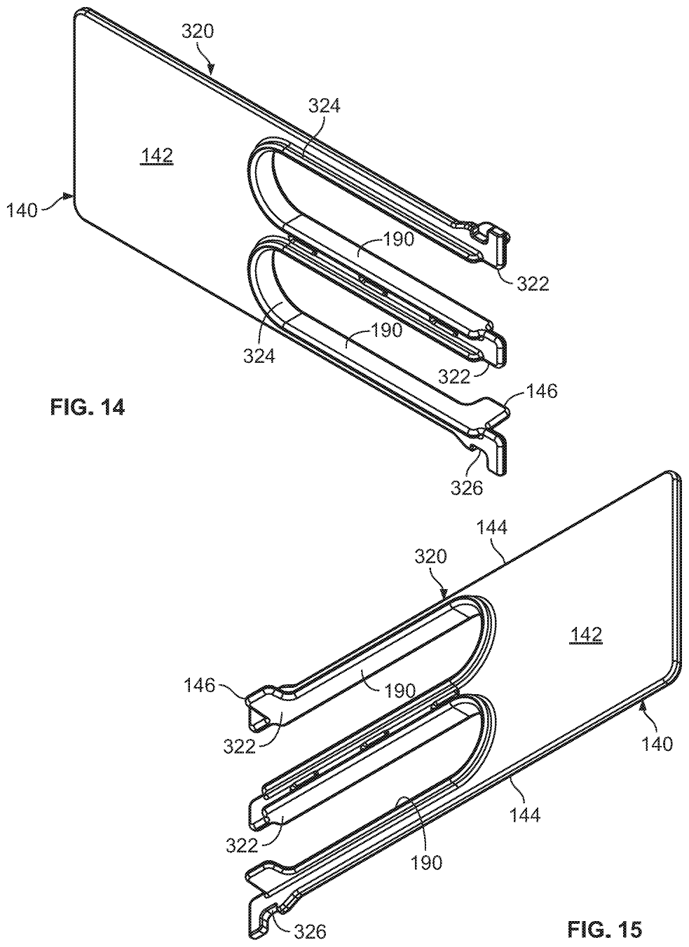

FIGS. 14 and 15 illustrate a third example implementation 320 of a cable insert 140. The cable insert 320 defines multiple open-ended, rear-facing slots 190. In the example shown, cable insert 320 defines two rear-facing slots 190. In other examples, the cable insert 320 can define additional rear-racing slots 190. In the example shown, each slot 190 extends about halfway into the body 142 of the insert 320. In other examples, each slot 190 may be deeper or shallower. In the example shown, a combination of the slots 190 extends over a majority of a height of the body 142. In other examples, the slots 190 may be thinner. In the example shown, the open end 322 of each slot 190 is substantially the same height as a remainder of the slot 190. In other examples, a height of the open end 322 may be reduced. In the example shown, a raised ridge 324 extend around a periphery of each slot 190. The ridge 324 may define a bend radius limiter or otherwise inhibit excessive bending of cables 180 routed through the respective slot 190.

In the example shown, the cable insert 320 includes latches 326 configured to engage a protruding tab or shoulder on the corresponding guide arrangement 150 or cable management arrangement 120, 220. In other examples, the cable insert 320 may include a latch tab 148. In certain examples, the cable inset 320 includes stopping tabs 146 to engage a rearward facing shoulder 156 of the guide arrangement 150 or cable management arrangement 120, 220.

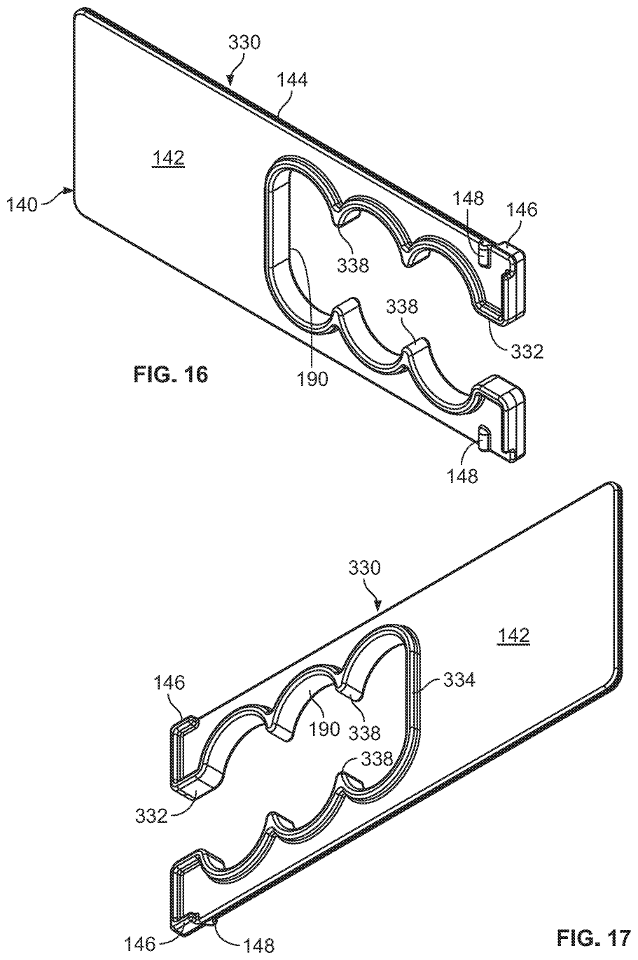

FIGS. 16 and 17 illustrate a fourth example implementation 330 of a cable insert 140. The cable insert 330 defines an open-ended, rear-facing slot 190. In the example shown, the slot 190 extends about halfway into the body 142 of the insert 330. In other examples, the slot 190 may be deeper or shallower. In the example shown, the slot 190 extends over a majority of a height of the body 142. In other examples, the slot 190 may be thinner. In the implementation shown, the slot 190 may define multiple sections partially segregated by extensions 338. In some examples, each section may be sized and shaped to receive a separate cable. For example, each section may be elongated to hold a flat cable or circular to hold a round cable. In other examples, each section is sized and shaped to hold a group of fibers from respective port modules or respective blades. In the example shown, the open end 332 of the slot 190 is reduced and may help to retain the cables 180 within the slot 190 once inserted. Other slot openings are possible. In the example shown, a raised ridge 334 extend around a periphery of the slot 190. The ridge 334 may define a bend radius limiter or otherwise inhibit excessive bending of cables 180 routed through the slot 190. In the example shown, the body 142 of the cable insert 330 includes a stop tab 146 and a latch tab 148. In other examples, the insert 330 may have other latching mechanisms.

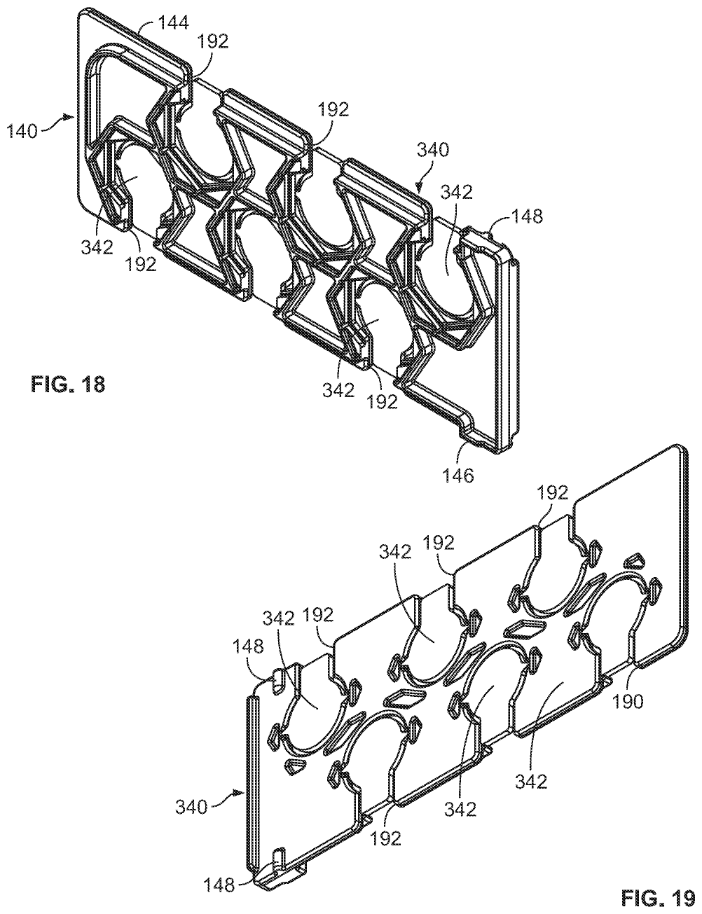

FIGS. 18 and 19 illustrate a fifth example implementation 340 of a cable insert 140. The cable insert 340 defines multiple open-ended slots 192 that face upwardly or downwardly. In the example shown, the cable insert 340 includes three upwardly-facing slots 192 and three downwardly-facing slots 192. In other examples, the cable insert 340 may include a greater or lesser number of upwardly- and/or downwardly-facing slots 192 (e.g., no upwardly and one or more downwardly, one or more upwardly and no downwardly, two upwardly and two downwardly, etc.). In certain examples, the cable insert 340 has a common number of upwardly- and downwardly-facing slots. In certain examples, one or more of the slots 192 are blocked by removable segments 342. For example, the segments 342 can be pushed, torn, broken, or otherwise removed from the slots 192 as the slots 192 become needed to hold cables 180.

The cables 180 are laterally inserted into the slots 192 through the open ends of the slots 192. In some examples, one or more bare cables 180 are inserted into a slot 192. In other examples, multiple cables 180 are grouped together using tape, a heat recoverable tubing, zip-ties or other holding mechanisms. In certain examples, a gland or other anchoring structure holds one or more cables 180. The gland or other anchoring structure can be slid into a respective one of the slots 192. Accordingly, the cables 180 can be anchored to the cable insert 340. In certain examples, the body 142 of the cable insert 340 may include structure (e.g., apertures) at which the glands may latch or otherwise secure. In certain examples, the body 142 is configured to attach to the glands so that no portion of the glands extend sufficiently into the cable management arrangement 320 to block a blade or port module from being removed through the cable management arrangement 320. In the example shown, the body 142 of the cable insert 340 includes a stop tab 146 and a latch tab 148. In other examples, the insert 340 may have other latching mechanisms. In the example shown, the cable insert 340 includes a handle 344 or other grip structure by which a user can pull the insert 340 out of the guide arrangement 150.

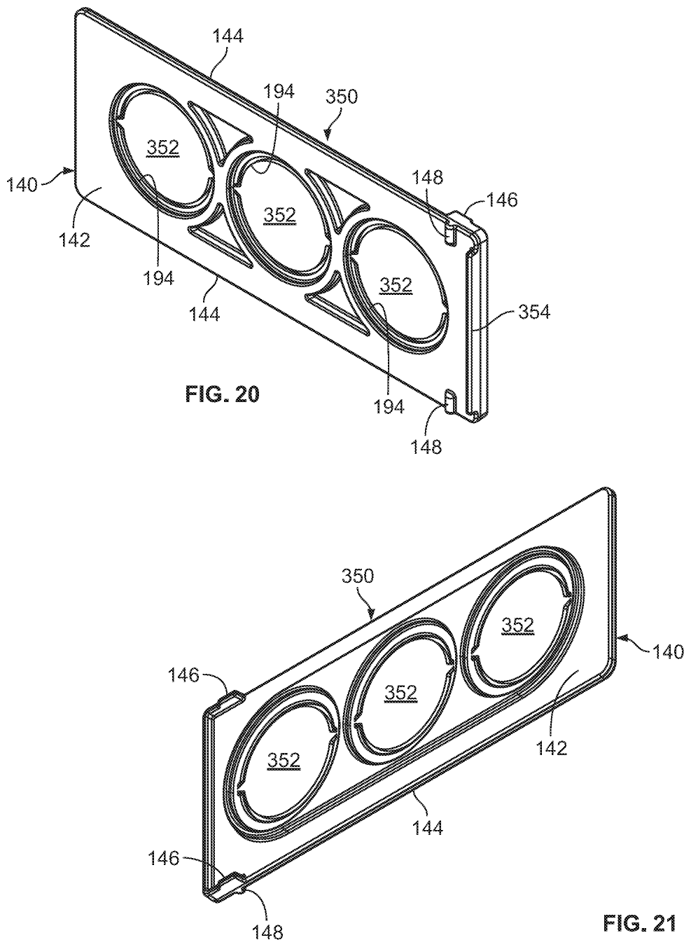

FIGS. 20 and 21 illustrate a sixth example implementation 350 of a cable insert 140. The cable insert 350 defines one or more apertures 194 that extend through the body 142 of the insert 350. In the example shown, the cable insert 350 includes three apertures 194. In other examples, the cable insert 350 may include a greater or lesser number of apertures 194. In certain examples, one or more of the apertures 194 are blocked by removable segments 352. For example, the segments 352 can be pushed, torn, broken, or otherwise removed from the apertures 194 as the apertures 194 become needed to hold cables 180.

The cables 180 are threaded into the apertures 194 to route the cables 180 through the insert 350. Accordingly, a connectorized end of each cable 180 is typically threaded through one of the apertures 194 prior to the connectorized end being plugged into the rear-facing port 174 of one of the port modules 170. In some examples, the cable 180 is threaded through the aperture 194 while the insert 350 is disconnected from the cable management arrangement 120, 220. In other examples, the cable 180 is threaded through the aperture 194 while the insert 350 is mounted to the cable management arrangement 120, 220.

In some examples, one or more bare cables 180 are threaded through the aperture(s) 194. In other examples, multiple cables 180 are grouped together using tape, a heat recoverable tubing, zip-ties or other holding mechanisms and threaded as a unit through the aperture(s) 194. In certain examples, a corrugated tube or other conduit surrounding the cables 180 is routed to one or more of the apertures 194. In certain examples, the corrugated tube or other conduit may be secured to the cable insert 350 at the aperture 194. In an example, the aperture 194 is sized to receive an end of the corrugated tube or other conduit therein.

In certain examples, a gland or other anchoring structure holds one or more cables 180. The cable(s) 180 can be threaded through the aperture 194 until the gland plugs into the aperture 194 or otherwise connects to the body 142 of the insert 350. Accordingly, the cables 180 can be anchored to the cable insert 350. In certain examples, the body 142 of the cable insert 350 may include structure (e.g., apertures) at which the glands may latch or otherwise secure. In certain examples, the body 142 is configured to attach to the glands so that no portion of the glands extend sufficiently into the cable management arrangement 320 to block a blade or port module from being removed through the cable management arrangement 320. In the example shown, the body 142 of the cable insert 350 includes a stop tab 146 and a latch tab 148. In other examples, the insert 350 may have other latching mechanisms. In the example shown, the cable insert 350 includes a handle 354 or other grip structure by which a user can pull the insert 350 out of the guide arrangement 150.

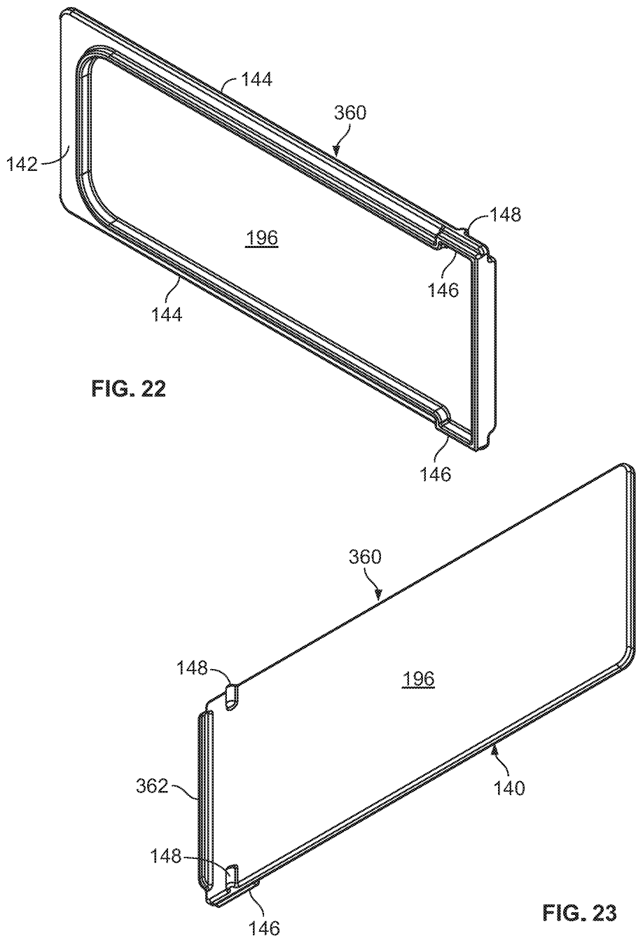

FIGS. 22 and 23 illustrate an insert 360 a solid body 196 that closes the slot 126, 226. In the example shown, the body 142 of the cable insert 360 includes a stop tab 146 and a latch tab 148. In other examples, the insert 360 may have other latching mechanisms. In certain examples, the inset 360 includes a handle 362 or other grip feature by which a user can pull the insert 360 out of the guide arrangement 150. In some examples, the insert 360 includes a removable body that closes the slot 126, 226 prior to being removed and leaves a rear-facing slot 190 when removed. In some implementations, cables 180 are routed to the chassis panel 100, 200 from only one side 103, 104, 203, 204. The insert 360 is mounted to the cable management arrangement 120, 220 at the side 103, 104, 203, 204 that does not receive the cables 180. A different insert (e.g., any of inserts 300-350) can be mounted to the cable management arrangement 120, 220 at the side 103, 104, 203, 204 that does receive the cables 180.

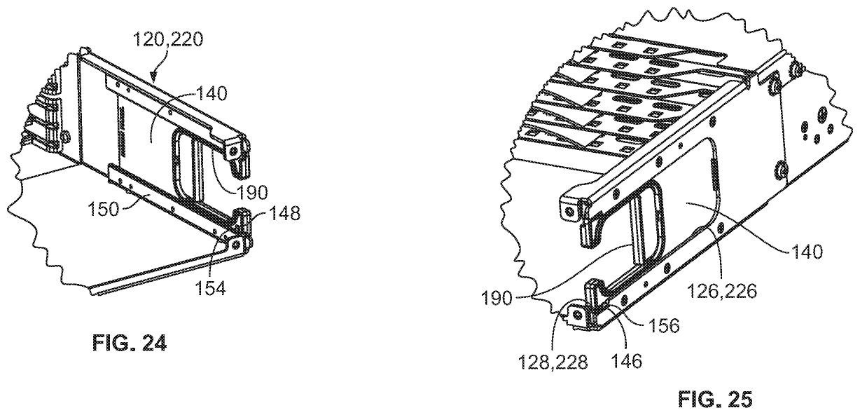

FIGS. 24 and 25 illustrate an example insert 140 received at the slot 126, 226 of the cable management arrangement 120. The edges 144 of the body 142 are disposed within the channels 152. Abutment between the body 142 and the channels 152 helps to retain the insert 140 at the cable management arrangement 120, 220 against forces applied to the insert 140 by the cables 180 (e.g., forces pushing the insert 140 along an axis transverse to the forward-rearward axis X). The latch tab 148 is received at the notch 158 of the resilient tab 154. The stop tab 146 abuts the rear shoulder 156.

In accordance with certain aspects of the disclosure, one method of cabling a chassis panel arrangement 100, 200 includes routing cables 180 through a management insert 140, 310, 320, 330, 340, 350 and plugging connectorized ends of the cables 180 into rearward-facing ports 174 of a port module 170. The method further includes sliding the port module 170 into the chassis panel 100, 200 along a forward-rearward axis X from an open rear of the chassis panel 100, 200; and sliding the management insert 140, 310, 320, 330, 340, 350 along the forward-rearward axis X into a slot 126, 226 defined in a sidewall 124, 224 of the chassis panel 100, 200.

In some examples, routing cables 180 through a management insert 140, 310, 320, 330, 340, 350 includes sliding cables through one or more slots 190, 192 of the insert 310, 320, 330, and 340. In other examples, routing cables 180 through a management insert 140, 310, 320, 330, 340, 350 includes threading the cables 180 through one or more apertures 194 of the insert 350.

In some examples, the cables 180 are anchored to the insert 140, 310, 320, 330, 340, 350. In other examples, the cables 180 are anchored to a separate part of the cable management arrangement 120, 220 (e.g., using clamps, cable ties, etc.)

In some examples, the insert 140, 310, 320, 330, 340, 350 is mounted to the cable management arrangement 120, 220 when the cables are routed therethrough. In other examples, the insert 140, 310, 320, 330, 340, 350 is disconnected from the cable management arrangement 120, 220 when the cables 180 are routed therethrough.

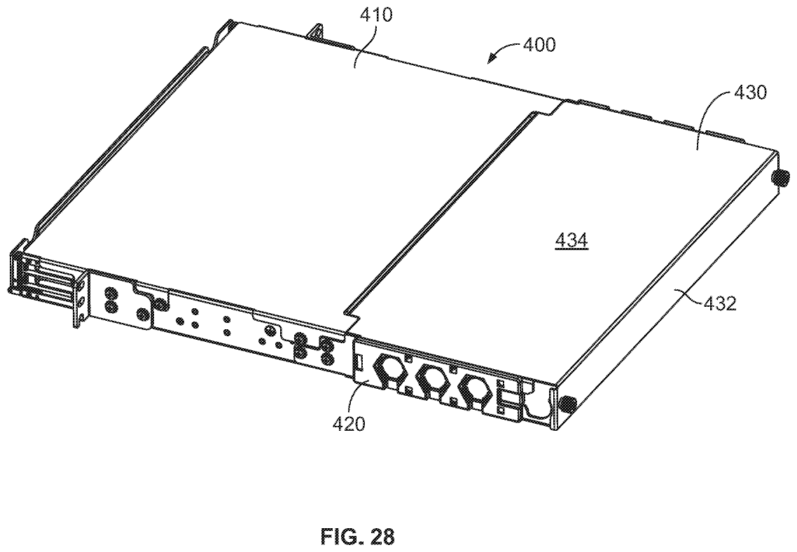

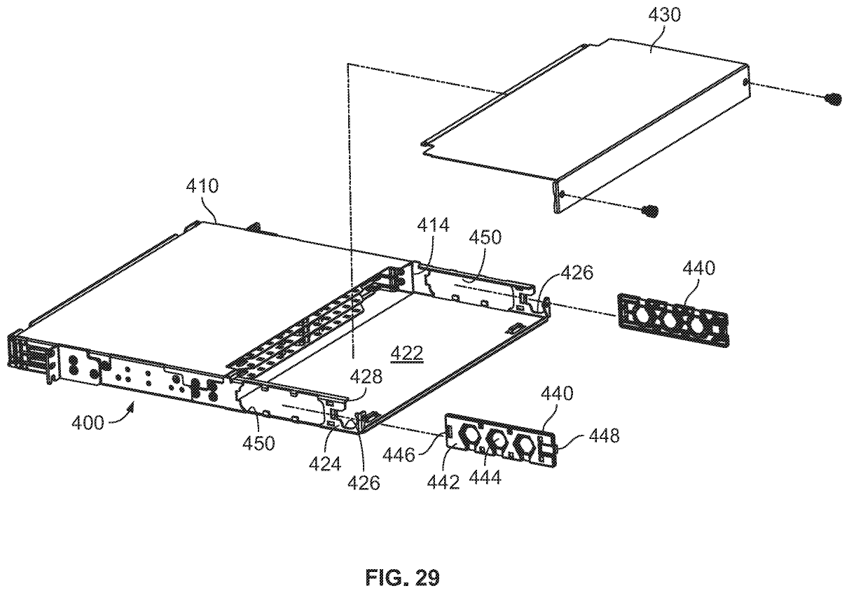

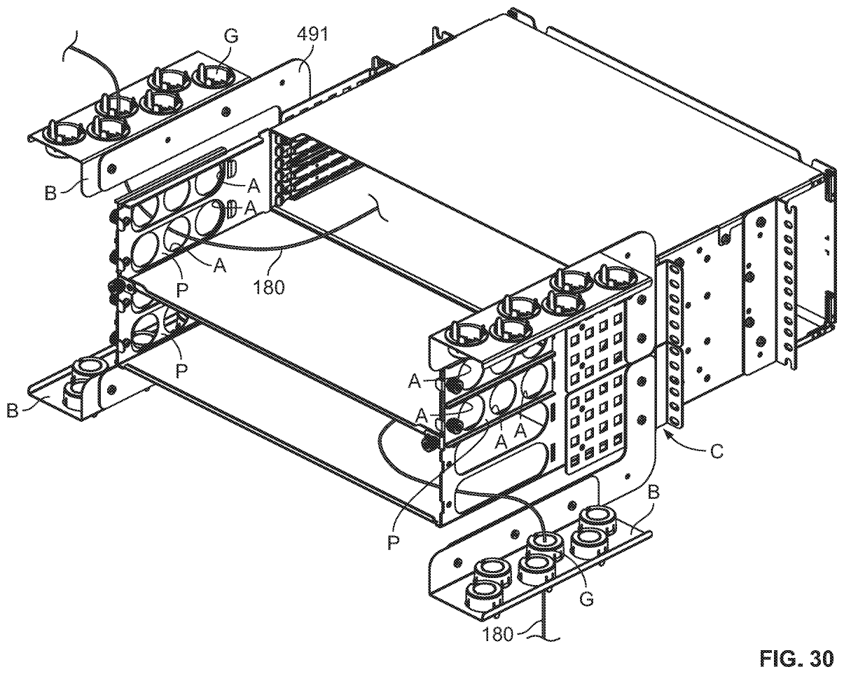

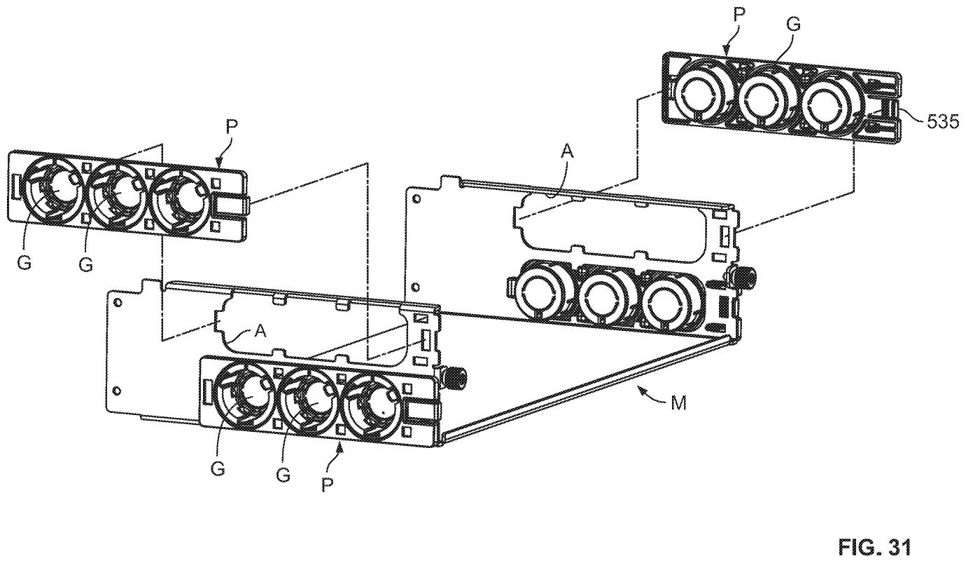

FIGS. 28 and 29 illustrate another example chassis panel 400 including a chassis body 410, a cable management arrangement 420, and a removable cover 430. The chassis body 410 defines an open front and an open rear through which one or more port modules 170 can be inserted and/or removed. The cover 430 is removed from the cable management arrangement 420 to expose the open rear 414 of the chassis body 410. Removing the cover 430 also exposes an interior of the cable management arrangement 420 in which cables 180 that are routed rearwardly from the port modules 170 within the chassis body 410 can be directed towards sidewalls 424 of the cable management arrangement 420.

The sidewalls 424 define multiple openings through which the cables 180 can exit the cable management arrangement 420. In certain implementations, the sidewalls 424 define a slot 426 having an open end 428 that faces at least partially rearward. In certain examples, the open end 428 of the slot 426 also faces at least partially upward. The cover 430 extends across the open end 428 of the slot 426 when mounted to the cable management arrangement 420. One or more cables 180 can be inserted into the slot 426 via the open end 428 when the cover 430 is removed from the cable management arrangement 420.

In some implementations, the slot 426 is small relative to the sidewall 424. In certain examples, the slot 426 may be less than half the size of the sidewall 424. In certain examples, the slot 426 may be less than a third the size of the sidewall 424. In certain examples, the slot 426 may be less than a quarter the size of the sidewall 424. In certain examples, the slot 426 may be less than a fifth the size of the sidewall 424. In some examples, the slot 426 is circular. In other examples, the slot 426 is elongated.

In certain implementations, the sidewalls 424 define an aperture 450 through which the cables 180 can be threaded. For examples, the cables 180 can be threaded through the aperture 350 prior to being routed to a port module 170. In certain examples, the apertures 450 are located sufficiently close to the open rear 414 of the chassis body 410 to provide finger access to blades and/or port modules disposed within the chassis body 410. For example, a user may access a latching system of the blade or port module and/or may access a latching member within the chassis body 410 that holds the blades and/or port modules within the chassis body 410.

In certain examples, a cable management insert 440 can be mounted at the aperture 450. The insert 440 includes a body 442 defining one or more apertures or slots 444. The body 442 can be latched or otherwise mounted to the sidewall 424. For example, the body 442 may define a tab 446 and a resilient finger 448 at opposite ends of the body 442. The apertures or slots 444 may have removable sections closing the apertures or slots 444 until ready for use.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A chassis panel comprising:
a chassis body having an open front and an open rear providing access to an interior, the chassis body defining a forward-rearward axis extending between the open front and the open rear;
a port module disposed within the chassis body, the port module defining at least one rear-facing port;
a cable management arrangement disposed at the open rear of the chassis body, the cable management arrangement having sidewalls, at least one of the sidewalls defining a slot having an open rear; and
a management insert configured to mount to the at least one sidewall at the slot, the management insert being installable and removable at the slot by sliding the management insert past the open rear of the slot along the forward-rearward axis.

2. The chassis panel of claim 1, wherein the port module is configured to move relative to the chassis body about the forward-rearward axis.

3. The chassis panel of claim 1, wherein the management insert snaps into position at the slot.

4. The chassis panel of claim 1, wherein the management insert defines an open-ended slot facing rearward.

5. The chassis panel of claim 4, wherein the open-ended slot is oblong-shaped.

6. The chassis panel of claim 4, wherein the open-ended slot defines separate cable regions.

7. The chassis panel of claim 1, wherein the management insert carries a cable anchor.

8. The chassis panel of claim 7, wherein the management insert carries a plurality of cable anchors.

9. The chassis panel of claim 1, wherein the management insert carries a cable gland.

10. The chassis panel of claim 9, wherein the management insert carries a plurality of cable glands.

11. The chassis panel of claim 1, further comprising a rear cover that mounts to the cable management arrangement to block access to the open rear of the chassis body and to block access to the open rear of the slot.

12. A method of cabling a chassis panel arrangement comprising:
routing cables through a management insert;
plugging connectorized ends of the cables into rearward-facing ports of a port module;
sliding the port module into the chassis panel arrangement along a forward-rearward axis from an open rear of the chassis panel arrangement; and
sliding the management insert along the forward-rearward axis into a slot defined in a sidewall of the chassis panel arrangement.

13. The method of claim 12, wherein sliding the management insert includes latching the management insert at the slot.

14. The method of claim 12, wherein routing cables through the management insert includes sliding the cables into the management insert through an open-ended slot defined by the management insert, the open-ended slot facing rearward.

15. The method of claim 12, wherein routing cables through the management insert includes threading the cables through apertures defined by the management insert.

16. The method of claim 15, wherein the management insert includes a plate and the apertures are defined by the plate.

17. The method of claim 15, wherein the management insert includes a plate and the apertures are defined by cable anchors carried by the plate.

18. The method of claim 12, further comprising removing the port module from the chassis panel arrangement by sliding the port module rearwardly along the forward-rearward axis and sliding the management insert rearwardly along the forward-rearward axis.

19. The method of claim 12, wherein routing the cables through the management insert comprises routing the cables through a plurality of management inserts; and sliding the management insert along the forward-rearward axis into the slot comprises sliding the management inserts along the forward-rearward axis into respective slots.

20. The method of claim 12, further comprising mounting a rear cover to the chassis panel arrangement to block access to the slot and to the open rear of the chassis panel arrangement.
